(19) United States
(12) Patent Application Publication
(10) Pub. No.: US 2009/0304149 A1
(43) Pub. Date: Dec. 10, 2009

(54) X-RAY DETECTOR IMAGING WITH POLYCHROMATIC SPECTRA

(76) Inventors: Christoph Herrmann, Aachen (DE); Guenter Zeitler, Aachen (DE); Christian Baeumer, Hergenrath (BE); Klaus Jurgen Engel, Aachen (DE)

Correspondence Address: PHILIPS INTELLECTUAL PROPERTY & STANDARDS, P. O. Box 3001, BRIARCLIFF MANOR, NY, 10510, US

(21) Appl. No.: 11/996,376

(22) PCT Filed: Jul. 12, 2006
(86) PCT No.: PCT/IB06/52362

§ 371 Date: Oct. 28, 2008

Related U.S. Application Data
(60) Provisional application No. 60/701,634, filed on Jul. 22, 2005.

(51) Int. Cl. G01N 23/04; G01T 1/24

(52) U.S. Cl. 378/62; 250/370.09

(57) ABSTRACT

An x-ray detector has a sensor (24) absorbing x-ray quanta of polychromatic spectra and generating an electric sensor signal corresponding to the absorbed x-ray quanta. There is at least one counting channel (430) including a plurality of discriminators (420) each counting a number of charge signals (450) detected at a different respective threshold since a beginning of a measurement interval and an integrating channel (440) which measures overall charge of the charge signals detected since the beginning of the measurement interval.

The present invention relates generally to X-ray imaging. More particularly, the present invention relates to an X-ray detector and an X-ray imaging method using polychromatic X-ray spectra.

A conventional invasive procedure for medical imaging includes the insertion of catheters into, for example, coronary arteries. Although selective arterial angiography can provide excellent images of coronary arteries and their anatomic configuration, it is not suitable for general screening or repetitive controls in clinical research.

K-edge digital subtraction angiography is an imaging method using monochromatic x-rays from synchrotron sources. After intravenous (IV) injection of a contrast agent such as iodine, two images are produced with monochromatic beams, above and below the K-edge of the contrast agent. The logarithmic subtraction of the two measurements results in a contrast agent enhanced image, which can be precisely quantified. This technique is less invasive than the conventional imaging procedure and can be used to follow up on patients after coronary interventions. However, the K-edge digital subtraction angiography method has a disadvantage that the synchrotron sources producing the monochromatic x-ray beams are very expensive and the device as such is very bulky.

While relatively inexpensive non-invasive methods such as magnetic resonance imaging (MRI), computed tomography (CT), and ultrasound are known, they provide less accurate images. In particular, multi-slice spiral computed tomography (MSCT) frequently has incomplete interpretability caused by motion artifacts and calcifications.

It is known to decompose the mass attenuation u(E,x) into an energy-dependent (and location-independent) part and an energy-independent (and location-dependent) part through Photo-effect and Compton scattering:

u(E,x)=a(x)E⁻³+b(x)f_{KN}(E)

where f_{KN}(E) is the Klein-Nichina formula, hence allowing a similar approach to obtain a(x),b(x) from reconstructing the integral of a(x)(dx and b(x)dx, which are again obtained from solving a similar system of two non-linear equations. See Alvarez et al., “Energy selective reconstructions in X-ray Computerized Topography”, Phys. Med. Biol. 1976; and Lehmann et al., “Generalised image combination in dual KVP digital radiography”, Med. Phys. 8(5), 1981. In this approach, however, there is no direct relationship to the mass density of the materials. Instead one would obtain a Photoeffect image and a Compton Scattering image. For coronary artery imaging with a contrast agent, this approach may be helpful with the decomposition:

u(E,x)=a(x)E⁻³+b(x)f_{KN}(E)+u*_{Ca}(E)p_{Ca}(x).

Here, the Photo-effect term already covers parts of the contrast agent term, which might falsify the determination of the contrast agent's mass density as a function of the location.

Yet a different prior art approach is the so-called pZ projection which determines, from at least two attenuation values u₁ and u₂ (so-called “effective attenuation coefficients”, which differ from the normal attenuation coefficient) with different “spectral weighting”, the mass density p(x) and the atomic number Z(x) of a scanned object as a function of the location. See Heismann et al., “Density and atomic number measurements with spectral x-ray attenuation method”, Journal of Applied Phys., Vol. 94, No. 3, August 2003. The considered ways of spectral weighting are two measurements with different x-ray source spectra, two measurements with different detector sensitivities or one measurement with an energy-resolving detector, i.e., different spectral detector sensitivities are realized at once. Obviously, this approach does not consider the factorization of u(E,x) into components, which only depend on E and components, which only depend on x.

The preciseness of the quantitative information is an essential aspect in coronary angiography. Hence, there is a need for an X-ray detector and a method of non-invasive imaging that can be applied with standard CT scanners using polychromatic spectra and contrast media, and that can provide precise quantitative information on a body part of interest, such as vessel lumen sizes in coronary arteries.

It is an aim of the preferred embodiments of the invention to address and resolve the aforesaid needs. In one aspect, the preferred embodiments provide a detector, which allows, based on a mathematical approach for displaying, for example, coronary vessels including the thickness of contrast medium contained in these vessels, so that the lumen size can be quantified as well as the thickness of calcified vessel areas allowing for assessing calcifications.

It is an object to, for example, compute the axial dimension of the coronary arteries and the amount of iodine they contain so that a stenosis can be detected and quantified. It is also an object to have a procedure that is suitable to the follow-up of the stenosis observed after a first coronary angiography based on selective arterial angiography.

The foregoing and still other objects and advantages of the present invention will be more apparent from the following detailed explanation of the preferred embodiments in connection with the accompanying drawings.

The accompanying drawings, in which like reference characters denote like elements, show exemplary aspects of the preferred embodiments of the invention. Such aspects are shown by way of example rather than limitation.

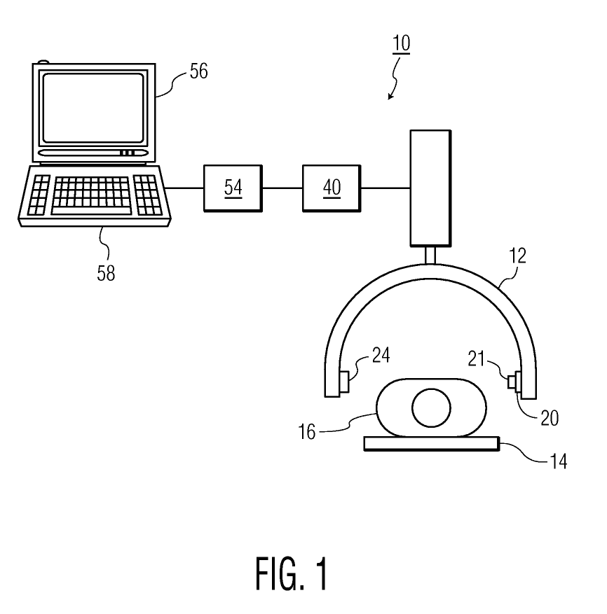

FIG. 1 illustrates an example of a CT scanner with which embodiments of the present invention may be implemented.

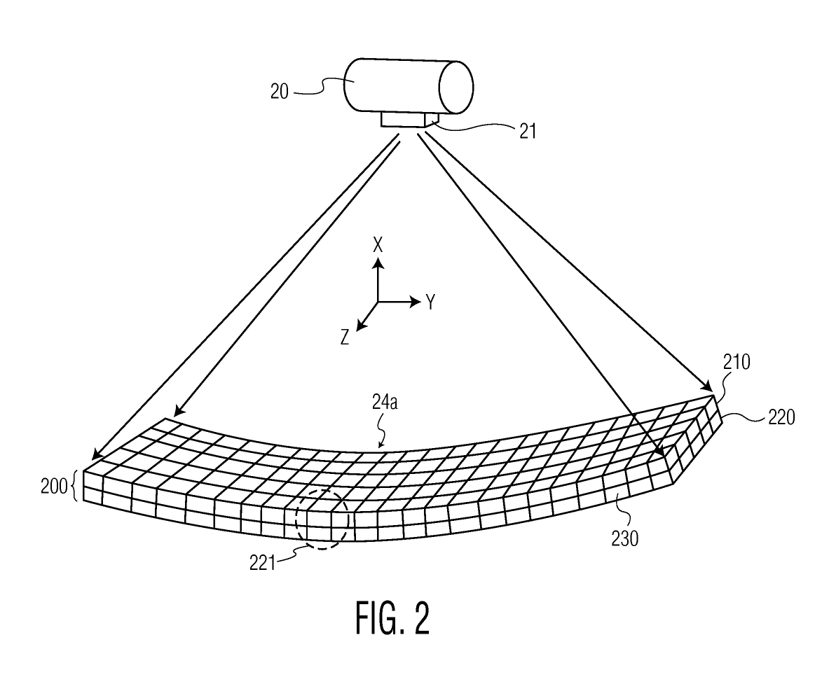

FIG. 2 illustrates the mass attenuation coefficient of various substances.

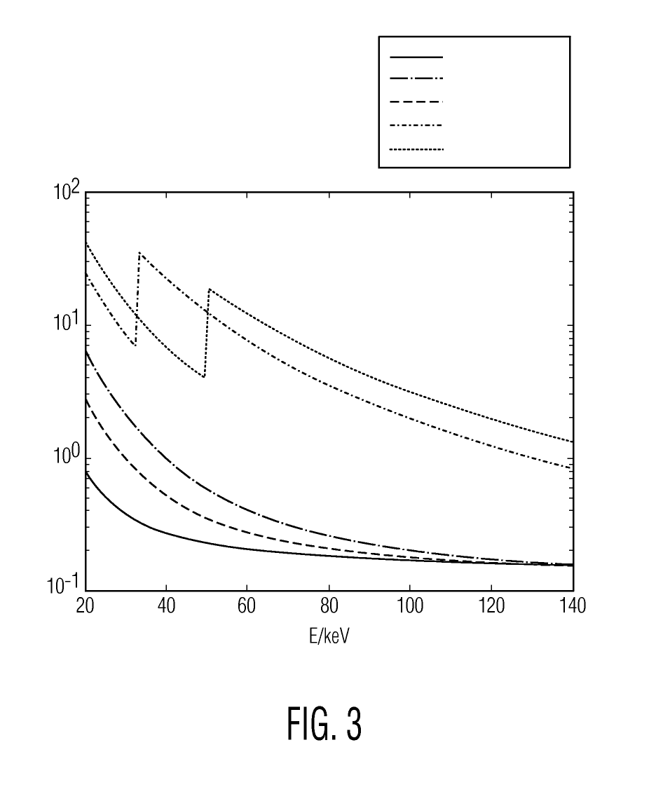

FIG. 3 illustrates an example of a sensor assembly for use with the CT scanner shown in FIG. 1.

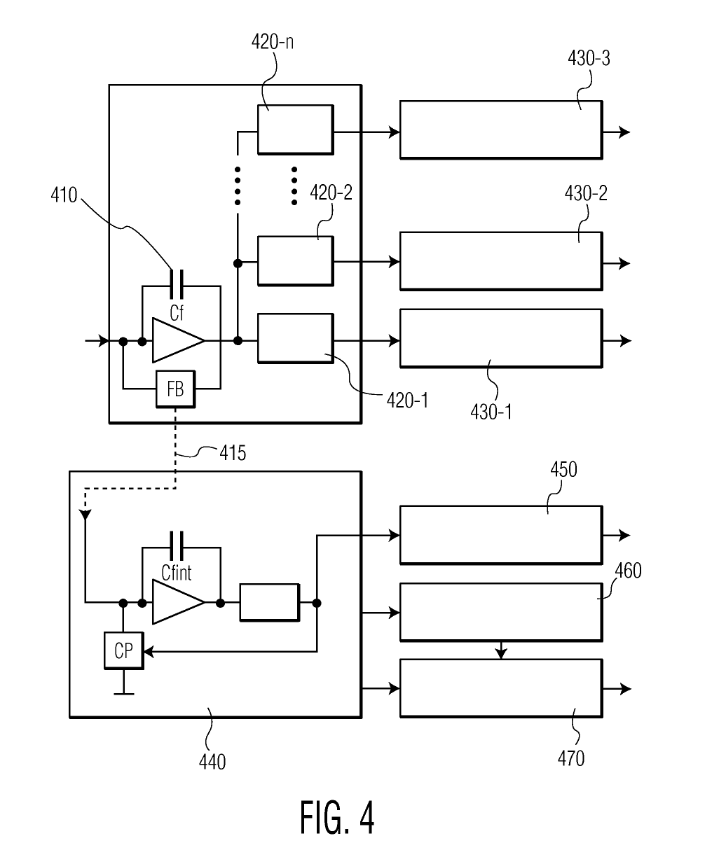

FIG. 4 is a block diagram of the imaging circuitry according to an example embodiment of the invention.

The preferred embodiments of the invention may be used with any X-ray system, but are preferably utilized on X-ray computed topography (CT) scanners. FIG. 1 illustrates an exemplary CT scanner 10 with which the preferred embodiments of the present invention may be implemented. The CT scanner 10 includes a support 12 and a table 14 for supporting a patient 16. The support 12 includes a x-ray source assembly 20 that projects a beam of x-rays, such as a fan beam or a cone beam, towards a sensor assembly 24 on an opposite side of the support 12 while a portion of the patient 16 is positioned between the x-ray source assembly 20 and the sensor assembly 24.

The x-ray source assembly 20 may be configured to deliver radiation at a plurality of energy levels, and the sensor assembly 24 may be configured to generate image data in response to radiation at different energy levels. The x-ray source assembly 20 may include a collimator 21 for adjusting a shape of the x-ray beam. The collimator 21 may include one or more filters (not shown) for creating radiation with certain prescribed characteristics. The sensor assembly 24 has a plurality of sensor elements configured for sensing a x-ray that passes through the patient 16. Each sensor element generates an electrical signal representative of an intensity of the x-ray beam as it passes through the patient 16.

The support 12 may be configured to rotate about the patient 16. In another embodiment, the support 12 may be configured to rotate about the patient 16 while they are standing (or sitting) in an upright position. The positioning of the support 12 and patient 16 are not limited to the examples illustrated previously, and the support 12 may have other configurations (e.g., positions or orientations of an axis of rotation), depending on a position and orientation of a body part for which imaging is desired.

In the illustrated embodiment, the CT scanner 10 also includes a processor 54, a monitor 56 for displaying data, and an input device 58, such as a keyboard or a mouse, for inputting data. The processor 54 is coupled to a control 40. The rotation of the support 12 and the operation of the x-ray source assembly 20 are controlled by the control 40, which provides power and timing signals to the x-ray source assembly 20 and controls a rotational speed and position of the support 12 based on signals received from the processor 54. The control 40 also controls an operation of the sensor assembly 24. For example, the control 40 can control a timing of when image signal/data are read out from the sensor assembly 24, and/or a manner (e.g., by rows or columns) in which image signal/data are read out from the sensor assembly 24. Although the control 40 is shown as a separate component from the support 12 and the processor 54, in alternative embodiments, the control 40 can be a part of the support 12 or the processor 54.

During a scan to acquire x-ray projection data (i.e., CT image data), the x-ray source assembly 20 projects a beam of x-rays towards the sensor assembly 24 on an opposite side of the support 12, while the support 12 rotates about the patient 16. In one embodiment, the support 12 makes a 360 degree rotation around the patient 16 during image data acquisition. Alternatively, if a full cone detector is used, the CT scanner 10 may acquire data while the support 12 rotates 180 degrees plus the angle of the beam pattern. Other angles of rotation may also be used, depending on the particular system being employed. In one embodiment, the sensor assembly 24 is configured to generate at least 900 frames of images in less than 1 second. In such a case, the support 12 only needs to rotate around the patient 18 once in order to collect sufficient amount of image data for reconstruction of computed tomography images. In other embodiments, the sensor 24 may be configured to generate frames at other speeds.

The patient 16 is positioned such that the positioning is disposed between the x-ray source assembly 20 and the sensor assembly 24. After a prescribed time (e.g., 150 seconds) measured from the point of contrast injection has lapsed, the support 12 then rotates about the patient 16 to generate two sets of image data. The two sets of image data may be generated in quick succession (e.g., within 5 to 20 milliseconds) using radiation at different levels, or within any time period as long as the first and the second sets of image data are captured fast enough to render the object being imaged to appear motionless. As the support 12 rotates about the patient 16, the x-ray source assembly 20 alternately emits radiation at a first and a second energy levels. Particularly, the radiation should have a first energy level that is below a k-absorption edge (K-edge) of the contrast agent, and a second energy level that is above the k-edge of the contrast agent. The emitted radiation at both levels is attenuated by the patient 16 and impinges on the sensor assembly 24. FIG. 2 illustrates mass attenuation coefficients for various substances.

The sensor assembly 24 generates first and second sets of image signals/data in response to radiation impinging thereon at the first and second levels, respectively. Additional sets of image data for different support angles can be generated as the support 12 rotates about the patient. After a desired number of sets of image data (e.g., sufficient for reconstruction of volumetric image) have been generated, the image data can be stored in a computer readable medium for later processing. In some embodiments, the support 12 makes at least one rotation to generate the sets of image data. In alternative embodiments, the support 12 makes a partial rotation to generate the sets of image data.

The sensor assembly 24 can be variously constructed. FIG. 2 shows an exemplary sensor assembly 24a comprising an imager 200 that includes a x-ray conversion layer 210 made from a scintillator element, such as Cesium Iodide (Csl), and a photo detector array 220 (e.g., a photodiode layer) coupled to the x-ray conversion layer 210. The x-ray conversion layer 210 generates light photons in response to x-ray radiation, and the photo detector array 220, which includes a plurality of detector elements 221, is configured to generate electrical signal in response to the light photons from the x-ray conversion layer 210. The x-ray conversion layer 210 and the photo detector array 220 may both be pixilated, thereby forming a plurality of imaging elements 230, or the x-ray conversion layer 210 may be non-pixilated. The imager 200 may have a curvilinear surface (e.g., a partial circular arc). Such surface configuration is beneficial in that each of the imaging elements 230 of the imager 200 is located substantially the same distance from the x-ray source 20 assembly. The imager 200 can alternatively have a rectilinear surface or a surface having other profiles. Each image element 230 (or pixel) may have a cross sectional dimension that is approximately 200 microns or more, and more preferably, approximately 400 microns or more, although image elements having other dimensions may also be used. Preferred pixel size can be determined by a prescribed spatial resolution. Inage elements 230 having 200 to 400 microns in cross sectional dimension are good for general anatomy imaging, while other cross sectional dimensions may be preferred for specific body parts. The imager 200 can be made from amorphous silicon, crystal and silicon wafers, crystal and silicon substrate, or flexible substrate (e.g., plastic), and may be constructed using flat panel technologies (e.g., active-matrix flat panel technologies) or other techniques known in the art of making imaging device.

Each of the image elements 230 may comprise a photodiode (forming part of the detector element 221) that generates an electrical signal in response to a light input. The photodiode receives light input from the x-ray conversion layer 210 that generates light in response to x-rays. The photodiodes are connected to an array bias voltage to supply a reverse bias voltage for the image elements. A transistor (such as a thin-film N-type FET) functions as a switching element for the image element 230. When it is desired to capture image data from the image elements 230, control signals are sent to a gate driver to “select” the gate(s) of transistors. Electrical signals from the photodiodes “selected” by the gate driver are then sent to charge amplifiers, which outputs image signals/data for further image processing/display.

In one embodiment, the image data are sampled from the image elements 230 one line at a time. Alternatively, the image data from a plurality of lines of the image elements 230 can be sampled simultaneously. Such arrangement reduces the time it takes to readout signals from all lines of image elements 230 in the imager 200. This in turn, improves a frame rate (i.e., number of frames that can be generated by the imager 200 per second) of the imager 200. During use, radiation at a first energy level impinges on the sensor assembly 24a, which then generates image signals/data in response to the radiation at the first energy level. After the image signals/data are read out from the photo detector array 220, radiation at a second energy level is directed to the detector assembly 24a. The assembly 24a then generates image signals/data in response to the radiation at the second energy level. In one embodiment, one or more filters can be placed between the x-ray source assembly 20 and the sensor assembly 24 (e.g., on top of the conversion layer 210) before radiation at either or both of the energy levels is directed to the sensor assembly 24a. The filter(s) alters radiation exiting from the patient 16, such that radiation having a desired characteristic will be received by the sensor assembly 24a. In one embodiment, a first filter(s) can be used to maximize or optimize a detective quantum efficiency of the sensor assembly 24a for radiation at a first energy level, while a second filter(s) can be used to maximize or optimize detective quantum efficiency of the sensor assembly 24a for radiation at a second energy level. For example, the sensor assembly 24a may have a uniform sensitivity to all photon energies in a spectrum, may have a sensitivity that is proportional to photon energy, or may have “holes” where photons of certain energy ranges are not efficiently absorbed. For each of these different types of sensor assembly 24a, one or more filters can be selected to maximize an efficiency of the system 10 (e.g., maximizing a response of the system 10 in measuring the injected contrast agent, and/or minimizing dose delivery and time). The placement of the filter(s) can be accomplished manually or mechanically. In some embodiments, the filters can be parts of the sensor assembly 24.

In alternative embodiments, the sensor assembly 24 may use different detection schemes. For example, in alternative embodiments, instead of having the x-ray conversion layer 310, the sensor assembly 24 can include an imager having a photoconductor, which generates electron-hole-pairs or charges in response to x-rays.

The majority of the X-ray quanta is absorbed in the sensor assembly 200 so as to be converted, after absorption, into an electric charge signal whose magnitude is approximately proportional to the absorbed energy. In the present context, it is not important whether the conversion of the X-ray quanta into the charge signals takes place directly (by means of so-termed directly converting materials, for example, gases such as Xe, semiconductors such as GaAs, CdTe, CdZnTe, or photoconductors such as Se, PbI.sub.2 or PbO) or indirectly (for example, by conversion into low energy light quanta by means of a scintillating material and subsequent detection by a photodiode of crystalline or amorphous silicon).

The preferred embodiments of the invention improve upon the X-ray detector 24 in such a manner that K-edge imaging becomes possible with polychromatic spectra. Three or more measurements are obtained in the detector 24 in order to determine unknowns, which are real line integrals. A counting channel includes one or a small number of further counting thresholds, including a threshold which is selected in consideration of the K-edge energy of the contrast medium to be used in the imaging procedure.

For K-edge imaging, it is preferred that one of the further counting threshold(s) is at the energy value of the K-edge. In other words, the further threshold gives rise to two energy bins, preferably one below and one above the K-edge. With this approach, the three equations are (E1 denoting the K-edge energy):

$$- ln ( \frac{{\int }_{E min}^{E max} E Φ ( E ) {e}^{- {μ}_{t}^{*} ( E ) \int {ρ}_{t} ( \vec{x} ) d \vec{x} - {μ}_{b}^{*} ( E ) \int {ρ}_{b} ( \vec{x} ) d \vec{x} - {μ}_{I}^{*} ( E ) \int {ρ}_{I} ( \vec{x} ) d \vec{x}} d E}{{\int }_{E max}^{E min} E Φ ( E ) d E} ) = \text{:} {M}_{1}$$

### Integration:

$$- ln ( \frac{{\int }_{E min}^{E 1} Φ ( E ) {e}^{- {μ}_{t}^{*} ( E ) \int {ρ}_{t} ( \vec{x} ) d \vec{x} - {μ}_{b}^{*} ( E ) \int {ρ}_{b} ( \vec{x} ) d \vec{x} - {μ}_{I}^{*} ( E ) \int {ρ}_{I} ( \vec{x} ) d \vec{x}} d E}{{\int }_{E min}^{E 1} Φ ( E ) d E} ) = \text{:} {M}_{2}$$

Counting below K-edge:

$$- ln ( \frac{{\int }_{E 1}^{E max} Φ ( E ) {e}^{- {μ}_{t}^{*} ( E ) \int {ρ}_{t} ( \vec{x} ) d \vec{x} - {μ}_{b}^{*} ( E ) \int {ρ}_{b} ( \vec{x} ) d \vec{x} - {μ}_{I}^{*} ( E ) \int {ρ}_{I} ( \vec{x} ) d \vec{x}} d E}{{\int }_{E 1}^{E max} Φ ( E ) d E} ) = \text{:} {M}_{3}$$

Counting above K-edge:

The reconstructed quantity is the mass density, i.e., a magnitude, which is directly related to the concentration of the material in the scanned body part. For dealing with coronary calcifications, a fourth summand may be necessary and sufficient, which accounts for the calcification part of the image. It may allow for quantifying plaque thickness, i.e., the linear attenuation coefficient would be decomposed according to the equation:

μ(E,\vec{x})=μₜ*(E)ρₜ(\vec{x})+μ_{b}*(E)ρ_{b}(\vec{x})+μ_{I}*(E)ρ_{I}(\vec{x})+μ_{Ca}*(E)ρ_{Ca}(\vec{x}).

This approach works under the assumption that different soft-tissue materials have a similar mass attenuation Uₜ*(E) and density pₜ(x), while that of bone, iodine (or gadolinium) and calcification differs among bone, iodine and gadolinium, and is also sufficiently different from that of soft tissue. FIG. 3 illustrates the mass attenuation coefficient of various substances.

FIG. 4 shows the circuit architecture of the components in an evaluation unit of the detector according to a preferred embodiment. The evaluation unit may be realized as an integrated circuit, for example, as a CMOS circuit. The electric signals generated by the sensor are applied to an input pre-amplifier 410. The input pre-amplifier 410 converts the sensor signals into a different signal (for example, a voltage signal). It may be a charge sensitive amplifier (CSA), that is, typically an integrated circuit which includes a bleeding resistor. For each brief charge pulse at the input of pre-amplifier 410, an exponentially decreasing voltage is produced at the output, the surface area below this exponential curve being proportional to the charge within the pulse.

In order to have multiple threshold counting functionality, a plurality of discriminators 420-1 to 420-n are connected to the output of the preamplifier 410. Each of the discriminators may consist of a signal shaping amplifier and a comparator with an adjustable threshold value and generates a digital output signal (counting pulse) for each charge pulse from the sensor which is larger than a predetermined quantity of charge.

The lowest threshold (which may be implemented by discriminator 420-1) distinguishes counts generated by photons with minimum energy from counts generated by noise (e.g. electronic noise). The higher thresholds can be used for K-edge imaging. For example, with two discriminators, discriminator 420-2 may represent a threshold which corresponds to pulse sizes generated by the pre-amplifier 410 in response to sensor signals, which were generated by photons above the energy (K-edge energy), at which the K-edge of the used contrast medium is found.

In order to determine the photons with energy below the K-edge energy, the difference between the values of event counter 430-2 and event counter 430-1 is computed, while the photons with energy above the K-edge energy are given by the value of event counter 430-2. The counters 430-1 to 430-n may be electronic digital counters with a counting depth of n bits. Linearly fed back shift registers may be used to save space.

An integrating channel 440 receives a signal 415 from a feedback loop of preamplifier 410 and may be an “overall signal acquisition circuit” which detects the total quantity of charge indicated by the sensor signal during an integration period. This circuit may be realized by an integrator circuit with an analog output, and a voltage/frequency converter, or it may be realized in some other manner.

Using the additional integrating channel 440 rather than only a number of different counting channel (which would result in an energy resolving pulse counter) may be seen in the fact that the integration is done over the whole energy range so that the evaluation will not be quantum-limited, while this could well occur for some of the bins of an energy resolving pulse counter, especially if the energy-bin size is small, i.e. only few photons are counted per energy bin on average.

Charge packet counter 450 and time counter 460 determine an optimized estimation for the electrical charge generated during a measurement interval marked by time latch 470, which charge is proportional to the energy deposited by X-rays during the measurement interval. The count of the counters 430-1 to 430-n, and the result of the integration in integrating channel 440 are provided to a data processing unit (not shown). The data processing unit can thus evaluate the results of the counting channel as well as the integrating channel.

This arrangement enables a large dynamic range of the X-ray detector, because the more exact results of the counting channel can be used in the case of small quantum flows whereas in the case of large quantum flows the integrator channel that is more exact for large flows can be utilized. Therefore, the advantages of the two measuring methods can be combined by the counting as well as integrating acquisition of the signals in each pixel cell of an X-ray detector.

Moreover, in the case of average quantum flows it is possible to acquire additional information, which is not available in the case of separate application of a counting method or an integration method. Because the integrating channel detects the absorbed energy and the counting channel determines the number of X-ray quanta absorbed, combination of the two signals enables, for example, determination of the mean energy of the absorbed quanta. This mean energy is a measure of the radiation hardening occurring in the object being examined; such information can be advantageously used for the determination and discrimination of types of tissue.

An X-ray detector according to the above-described preferred embodiments facilitates clinical routine non-invasive procedures for coronary angiography based on X-ray CT scanners with polychromatic spectra sources. Since the X-Ray detector simultaneously integrates and counts with differentiating of a small number of energies, preferably including the energy of the K-edge of a contrast medium such as iodine or gadolinium, K-edge imaging becomes possible. It is possible to display quantitatively contrast medium areas within a scanned image as well as calcifications.

Since only very few energy bins are necessary, and due to the additional integration, such an X-ray detector has the advantage that the few counting channels as well as the integrating channel, are usually not quantum-limited, since the number of evaluated quanta per channel is normally high.

The present invention has been described with particular reference to certain preferred embodiments. It should be understood that the foregoing description and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

1. An x-ray detector, comprising:
(a) a sensor absorbing x-ray quanta of polychromatic spectra and generating an electric sensor signal corresponding to the absorbed x-ray quanta;
(b) at least one counting channel, said counting channel including a plurality of discriminators each counting a number of charge signals detected at a different respective threshold since a beginning of a measurement interval; and
(c) an integrating channel which measures overall charge of the charge signals detected since the beginning of the measurement interval.

2. The x-ray detector as claimed in claim 1, further comprising a pre-amplifier receiving the electric sensor signal from the sensor and providing an amplified signal in parallel to said plurality of discriminators.

3. The x-ray detector as claimed in claim 2, wherein said integrating channel receives an input signal from a feedback loop of said pre-amplifier.

4. The x-ray detector as claimed in claim 1, further comprising a plurality of event counters respectively corresponding to said plurality of discriminators and receiving respective outputs of said plurality of discriminators.

5. The x-ray detector as claimed in claim 1, further comprising a charge packet counter and a time counter receiving an output of said integrating channel.

6. The x-ray detector as claimed in claim 1, wherein one of said thresholds corresponds to the K-edge of a contrast agent being detected by said X-ray detector.

7. A method for non-invasive imaging of a mammalian body part, said method comprising:
(a) selecting a body part for non-invasive imaging, said body part comprising a first material having a first density and a second material having a second density;
(b) scanning the body part with an x-ray scanner having poly chromatic sources to provide a scanned image of the body part;
(c) obtaining at least 3 measurements including integrating and counting with a pre-determined level number of energy, including the energy of a contrast medium; and
(d) processing quantitative contrast areas of said materials within the scanned image.

8. The method of claim 7, wherein step (b) comprises applying three equations comprising an integration equation, a counting below k-edge equation and a counting above k-edge equation.

9. The method of claim 8, wherein the integration equation comprising;
$$- ln ( \frac{{\int }_{E min}^{E max} E Φ ( E ) {e}^{- {μ}_{t}^{*} ( E ) \int {ρ}_{t} ( \vec{x} ) d \vec{x} - {μ}_{b}^{*} ( E ) \int {ρ}_{b} ( \vec{x} ) d \vec{x} - {μ}_{I}^{*} ( E ) \int {ρ}_{I} ( \vec{x} ) d \vec{x}} d E}{{\int }_{E max}^{E min} E Φ ( E ) d E} ) = \text{:} {M}_{1}$$
the counting below k-edge equation comprising:
$$- ln ( \frac{{\int }_{E min}^{E 1} Φ ( E ) {e}^{- {μ}_{t}^{*} ( E ) \int {ρ}_{t} ( \vec{x} ) d \vec{x} - {μ}_{b}^{*} ( E ) \int {ρ}_{b} ( \vec{x} ) d \vec{x} - {μ}_{I}^{*} ( E ) \int {ρ}_{I} ( \vec{x} ) d \vec{x}} d E}{{\int }_{E min}^{E 1} Φ ( E ) d E} ) = \text{:} {M}_{2} ;$$
and
the counting above k-edge equation comprising
$$- ln ( \frac{{\int }_{E 1}^{E max} Φ ( E ) {e}^{- {μ}_{t}^{*} ( E ) \int {ρ}_{t} ( \vec{x} ) d \vec{x} - {μ}_{b}^{*} ( E ) \int {ρ}_{b} ( \vec{x} ) d \vec{x} - {μ}_{I}^{*} ( E ) \int {ρ}_{I} ( \vec{x} ) d \vec{x}} d E}{{\int }_{E 1}^{E max} Φ ( E ) d E} ) = \text{:} {M}_{3}$$
wherein E1 denotes the k-edge energy, M denotes a mass density having a magnitude related to the concentration of one of the said materials of said body part.

10. The method of claim 9, wherein the body part comprises a coronary artery, and the first material is coronary tissue and the second material is plaque.

11. The method of claim 10, wherein step (c) comprises a fourth equation for quantifying the plaque in this tissue.

12. The method of claim 11, wherein the fourth equation comprises
μ(E,\vec{x})=μₜ*(E)ρₜ(\vec{x})+μ_{b}*(E)ρ_{b}(\vec{x})+μ_{I}*(E)ρ_{I}(\vec{x})+μ_{Ca}*(E)ρ_{Ca}(\vec{x})
